(19) United States
(12) Patent Application Publication
(10) Pub. No.: US 2006/0244566 A1
(43) Pub. Date: Nov. 2, 2006

(54) System for secure RFID transactions

(76) Inventor: Scott L. Sullivan, (US)

Correspondence Address: Scott L. Sullivan, 634 Homer Ave. (#2), Palo Alto, CA, 94301, US

(21) Appl. No.: 11/412,849

(22) Filed: Apr. 27, 2006

Related U.S. Application Data
(60) Provisional application No. 60/676,487, filed on Apr. 28, 2005.

(51) Int. Cl. H04Q 5/22

(52) U.S. Cl. 340/10.1; 340/572.1; 340/5.61

(57) ABSTRACT

A RFID reader panel includes separate and isolated reading coils identified by distinguishing identifiers that allow a tag-holder to “tap” against one or more reading panels in a known sequence to increase the security of the transaction.

### CLAIM OF PRIORITY

Applicant hereby claims priority based on Provisional Patent Application No. 60/676,487, filed Apr. 28, 2005 and entitled: “Various Kitchen Products, Automotive, Power Cord-Cover, Cell Phone Systems, Furniture, and a Traffic Light.” The content of the above-listed provisional patent application in its entirety is hereby incorporated by reference.

### BACKGROUND OF THE INVENTION

a) Field of the Invention

This invention generally relates to communication systems and, more particularly, to RFID communication systems.

b) Description of the Prior Art

Radio-Frequency Identification Devices (RFIDs) are used more and more in today's world to help easily transmit information from a transducer to a reader. One such application is being developed by Mastercard, Inc. wherein an RFID is embedded within a consumer's credit card. In use, the user merely has to swipe the card near an RFID reader panel to transmit the consumer's account information to the server that is connected to the panel. This information is then processed the same way that a conventional credit card transaction would be. The convenience is based on a “touch and go” benefit wherein the consumer can pay more quickly and move on. However great this benefit is, the convenience is not without serious security concerns. If the consumer loses his RFID credit card, then anyone holding that card can make purchases until perhaps the consumer notices and reports the loss. This invention addresses this and other related RFID security concerns.

### SUMMARY OF THE INVENTION

A RFID reader panel includes separate and isolated reading coils identified by distinguishing identifiers that allow a tag-holder to “tap” against one or more reading panels in a known sequence to increase the security of the transaction.

### DETAILED DESCRIPTION OF THE INVENTION

RFIDs (or radio frequency identification device) are well known and are starting to be placed on many products to help manage their distribution from manufacturing to the consumer. To help integrate the use of RFIDs into our daily lives, Applicant proposes the following RFID-related inventions:

RFID Reading Panel

According to this invention, an RFID reader panel includes separate reading coils that define separate physical regions or zones on the actual surface of the reader, which could be labeled A, B, C, D, for example. Prior to using the reader panel, a tag holder would first know by memory a particular sequence of tag-reading zones, which causes an “OK” signal to be generated. The sequence is similar to a conventional PIN number in concept, and is preferably a simple 1, 2, 3 or 4 combination. It is useful to provide a “last moment” level of security to help prevent misuse.

For example, perhaps a tag holder uses his RFID tag to prepay for gasoline at a gas station. Instead of the user just swiping the tag against a reader having a single pick-up coil behind a single panel, as is the case now with the Mobil “Speed Pass” system, he would now swipe the tag against or adjacent to the reader labeled “B” (of the four adjacent panels “A”, “B”, “C”, and “D”). Only then would the system consider a valid transaction. Perhaps the correct “code” would be “B”, then “C”, then “A”. The user would hear a “beep” (or see a light or some other indication) to know that the reader has read the tag for that particular panel section and that it is then OK to move on in the combination (“B”, beep, “C”, beep, “A”, final beep, a different note to indicate acceptance of final code). If a tag is stolen, the thief would have to know that “combination” of “panel taps” before effectively benefiting from using the tag. This described system of this invention is somewhat analogous to the use of a “pin” code, but the RFID code being read each time is used instead of the user pressing numbered buttons. Of course, other coded labels could be used to identify the reader panels, such as colored panels, pictures, musical tones or animal names, etc. Also, the particular shape of each panels can be specific and used to distinguish different panels so that a useful and effective “PIN” can be created.

The reading system of this invention can further include a display that the user interacts with during the transaction. For example, the user may first use the tag to identify himself to a connected computer. The computer read the ID code from the RFID tag and uses that information to link an account including a predetermined question to ask the rightful tag owner (the question would be displayed to the tag-holder on the screen). The tag holder would then use his tag to answer the question by moving the tag adjacent the appropriately labeled reader, depending on the correct answer for the question. For example, “what's your favorite color?”—“A—BLUE”, “B-RED”, etc. The user would answer the question using the tag and would then complete the transaction, if the answer is determined to be correct. If not correct, the computer may ask for another answer, or may lock-out that tag until proper ownership is verified, as is understood by those skilled in the art.

In use, a user would first select a reading coil (one of several located next to each other) by recognizing a pattern, number, letter, word, picture, design, or sound, etc. associated with the particular coil (or sequence of coils). Each coil includes a digital identifier (a “coil-ID”) so that a connected computer will be able to know which coil is which and which coil or coils were selected by the user. The particular coil (any or all of the selected coils) interrogate (or otherwise communicate with) a nearby RFID tag, as the user moves the tag next to the coil (usually within 2 inches or so, but this distance can be controlled in the design of the system). The ID information read off of the tag is sent to the computer. The computer can then compare the received tag ID data and the received coil-ID with information stored in a database. The user would have previously inputted this information with the database at an earlier time so that the computer can now compare this data to determine a match. If there is a positive match, then the computer will assume that the user of the RFID is an authorized user similar to how a banking ATM compares account information and PIN data with stored database information to authenticate the user.

RFID-Reading System

An RFID tag can be read by an appropriate reader when the tag is moved to within a prescribed distance thereto. According to this invention, the tag transmits a signal (along with the data or the transmitted signal is the data itself) which causes a nearby sound generator or light to activate for each particular item read. If the same tag is read twice, a different sound or light will activate to inform the operator that the item was read twice. This may be useful when RFIDs are used at a checkout counter (groceries). Also, the read information from each RFID tag can be immediately compared to information located at a local electronic device or at a connected (electrically or by wireless) computer, memory, or server and will display information (or activate a sound or illuminate a light) relating to the outcome of the comparison. For example, if the RFID tag is located on a product that has expired, the RFID data would be immediately received and compared to a current-date/time generator and a computer would determine that the product expiration date has passed. The computer would then cause an appropriate sound or light or display to generate to indicate that the product has expired. Or, the case of RFID tags located on food products, the tag holds data that can be read to cause a beep that would indicate such things as “low fat” product, or “sale item”, perhaps automatically, or at the request of the customer (as indicated by their ID, name, customer no., credit card number, etc. The nutritional information can be printed on a receipt, or emailed to the customer. This invention could be incorporated into a bar code reading system as well.

RFID Tag

According to another invention, an RFID tag includes more than a single ID code to be transmitted when interrogated by a reader. A switch located on the tag itself (or electrically connected to the tag) allows a user to change which signal data is sent to the reader. This can be useful in secure transactions wherein a reader/computer that knows the rightful owner of the tag, would create and display a question to the tag holder, such as “what is your favorite color” and the tag holder could then use the switch on the local tag to transmit a signal code to the reader that would answer the question. The switch could have 4 or 5 choices, for example, each of which would send a different code that would be linked to the different choices.

RFID Secure Reading System

To offer a secure RFID reading system, applicant proposes appropriate software that will generate an “unlock” signal only if one particular RFID tag is read within a prescribed amount of time from when another (or the same tag) is read. The system could signal a beeping sound, for example, when each tag is read so that the tag holder would know when to re-apply the tag to the reader to have the reader read the tag once more. For example, perhaps a secure door at a facility requires a master key holder (such as a guard) to be present when someone enters through. In such instance, the guard would hold one RFID tag and the visitor would hold a second RFID tag. One system would require both tags to be placed onto the reader pad (or adjacent reader pads) at the same time, or perhaps at different times, but within a period of time, such as within 5 seconds before an unlock signal is sent to the door. Alternatively, an RFID lock could require that a combination of RFID tags (each with a different “ID”) be read in a particular sequence before the lock opens.

RFID Reading Monitor

A big concern of the public regarding the use of RFID tags relates to issues of invasion of privacy. Opponents of RFID technology are concerned that powerful readers could be used (perhaps transported in vans around neighborhoods) to read the many products located within a person's home, or shopping cart. This information could be used for marketing purposes or worse. To help maintain “peace of mind” for the consumer, I propose a key-fob, or simple device (either a small hand held version, or a home version that perhaps resembles a smoke-detector) that scans the airwaves for common or standard RFID-reader frequencies (specifically 13.553 to 13.567 Mhz. Or 915 Mhz, whatever the standard frequency for RFID tags used with consumer products is to be used). The device would beep or vibrate or other if such frequencies are detected. Optionally, the device of this invention could record the location (using GPS technology) and the time (or perhaps activate a camera) so that the illegal RFID reading could be later investigated. In use, for example if I just purchased some products at a store and as I walk to my car, the device I carry (according to this invention) warns me that my products are being “read” again, I can then report the activity and help prevent further unsolicited RFID-tag reading using the time and location information stored in my device.

RFID Mouse

According to this invention, an otherwise conventional computer “mouse” (cursor pointer aid) includes an RFID reader and circuit so that a computer-user can quickly and easily read an RFID tag, such as one located on a product. The user simply lifts the mouse off a working surface and moves the mouse close to the RFID tag. According to this invention, when the mouse is lifted from the working surface, an appropriate circuit and sensor detects this motion and switches power to the onboard RFID-reading circuit. During normal use of the mouse, the RFID reader would remain turned off and would only turn on when the mouse is lifted from the surface (and preferably after a slight delay of about ½ to 1 second).

RFID information that is read from the nearby RFID tag is either stored within appropriate circuitry and memory within the mouse housing or is immediately transferred to a connected computer. Applicant foresees use of this type of mouse/RFID reader in pharmacies to help pharmacists as they use RFID technology and their computers to fill prescriptions.

RFID Tag

According to this invention, an RFID tag includes an LED or a sound generator (on the TAG itself to help the user (the person reading the tag) know when that particular tag has been read. Also, when a tag has been read, circuitry on the tag may be used to effectively “turn off” further signal transmission of the tag information for a period of time. Also, when a tag has been “read” by a nearby reader, the reader can then send a “read” signal back to the tag so that the tag can be turned off for a period of time.

What is claimed is:

1) A method for reading data from an interrogated RFID tag to control the operation of a device, said reading method comprising the steps of:
providing an RFID reader having at least two input coils, each of said coils being radio-wave isolated and physically separated from each other so that only one reader coil can read an interrogated tag at a time, said RFID reader being able to communicate with a computer database of stored information, each of said coil having a unique identifying coil-signal associated therewith;
selecting one of said two input coils;
physically moving said tag to within a reading distance of said selected coil;
allowing said selected reading coil to interrogate and receive tag-data from said tag;
communicating with said database;
digitally comparing said received tag-data and said coil-signal of said selected coil with stored information of said database;
generating a match-signal in response to a positive comparison of said digital comparing step; and
using said match signal to allow operation of said device.
